(19) United States
(12) Patent Application Publication
(10) Pub. No.: US 2012/0168682 A1
(43) Pub. Date: Jul. 5, 2012

(54) PEDOT/PSS COMPOSITION AND PEDOT/PSS FILM USING THE SAME

(75) Inventors: Youn Soo Kim, Seoul (KR); Yong Hyun Jin, Seoul (KR); Ji Soo Lee, Gyunggi-do (KR); Jong Young Lee, Gyunggi-do (KR); Sang Hwa Kim, Gyunggi-do (KR)

(73) Assignee: SAMSUNG ELECTRO-MECHANICS CO., LTD., Gyunggi-do (KR)

(21) Appl. No.: 13/038,351

(22) Filed: Mar. 1, 2011

(30) Foreign Application Priority Data
Dec. 30, 2010 (KR) 1020100138949

(51) Int. Cl. H01B 1/12

(52) U.S. Cl. 252/500

(57) ABSTRACT

Disclosed herein is a PEDOT/PSS composition, including PEDOT/PSS, a solvent, a compatibilizer and a water-soluble conductive polymer, and a transparent electrode. Since a transparent electrode is formed by adding a compatibilizer and a water-soluble conductive polymer to PEDOT/PSS, the transparent electrode has excellent flexibility, can be easily coated and has a low surface resistance of 240˜300 Ω/□, so that this transparent electrode can be used as a transparent electrode for displays.

### CROSS REFERENCE TO RELATED APPLICATION

This application claims the benefit of Korean Patent Application No. 10-2010-0138949, filed Dec. 30, 2010, entitled “PEDOT/PSS composition and PEDOT/PSS film using the same”, which is hereby incorporated by reference in its entirety into this application.

### BACKGROUND OF THE INVENTION

1. Technical Field

The present invention relates to a PEDOT/PSS composition and a PEDOT/PSS film using the same.

2. Description of the Related Art

As various electrical household appliances and communication appliances including computers have become digitalized and rapidly highly-functionalized, it is keenly required to realize portable displays. In order to realize these portable displays, electrode materials for the portable displays must be transparent and have low resistance, must have high flexibility so that the portable displays are mechanically stable to mechanical impact, and must not short-circuit or cause a great change in surface resistance even when apparatuses are overheated and thus exposed to high temperatures.

Currently, indium-tin oxide (ITO) is most frequently used as the material of a transparent electrode for displays. However, in the case of forming a transparent electrode using ITO, there are problems in that it is difficult to realize a large area as well as in that excessive costs are required. In particular, when an electrode is coated with ITO over a large area, there is a fatal problem in that surface resistance greatly changes, thus deteriorating the brightness and luminous efficiency of displays. Moreover, indium, which is a major raw material of ITO and is a limited mineral resource, is being rapidly exhausted with the expansion of the market for displays.

In order to overcome the problems of ITO, research into forming a transparent electrode using PEDOT/PSS having excellent flexibility and coatability is being made. However, when a transparent electrode is made of PEDOT/PSS, there is a problem in that it is difficult to use this transparent electrode as a transparent electrode for displays because it has a very high surface to resistance of 10⁵˜10⁹ Ω/□. Therefore, in order to decrease the surface resistance of the transparent electrode made of PEDOT/PSS, a method of forming a transparent electrode by adding dimethylsulfoxide (DMSO), ethyleneglycol, sorbitol or the like to PEDOT/PSS is being proposed. However, the transparent electrode formed by this method is also problematic in that this transparent electrode is insufficient to be used as a transparent electrode for displays and in that the surface resistance of this transparent electrode becomes higher due to a binder used for coating.

### SUMMARY OF THE INVENTION

Accordingly, the present invention has been devised to solve the above-mentioned problems, and the present invention intends to provide a PEDOT/PSS composition, which can decrease the surface resistance of a transparent electrode by adding a compatibilizer and a water-soluble conductive polymer to PEDOT/PSS, and a PEDOT/PSS film using the same.

An aspect of the present invention provides a PEDOT/PSS composition, including: PEDOT/PSS; a solvent; a compatibilizer; and a water-soluble conductive polymer.

Here, the compatibilizer may be included in an amount of 1˜10 wt %. Further, the water-soluble conductive polymer may be included in an amount of 0.1˜36 wt %.

Further, the compatibilizer may be a monomer, oligomer or polymer having one or more anion functional groups or amine functional groups.

Further, the anion functional group may include SO₄—, PO₄— and COO—.

Further, the compatibilizer may include polyvalent alcohol.

Further, the polyvalent alcohol may include polyvinyl alcohol and hydroxypropyl cellulose (HPC).

Further, the water-soluble conductive polymer may include polypyrrole and polyaniline.

Further, the solvent may be any one selected from aliphatic alcohols, aliphatic ketones, aliphatic carboxylic esters, aliphatic carboxylic amides, aromatic hydrocarbons, aliphatic hydrocarbons, acetonitrile, aliphatic sulfoxides, water, and mixtures thereof.

Another aspect of the present invention provides a PEDOT/PSS film, including: a substrate; and a transparent electrode formed by applying a PEDOT/PSS composition including PEDOT/PSS, a solvent, a compatibilizer and a water-soluble conductive polymer onto the substrate and then drying the PEDOT/PSS composition.

Here, the compatibilizer may include a monomer, oligomer or polymer having one or more anion functional groups or amine functional groups.

Further, the anion functional group may include SO₄—, PO₄— and COO—.

Further, the compatibilizer may include polyvalent alcohol.

Further, the polyvalent alcohol may include polyvinyl alcohol and hydroxypropyl cellulose (HPC).

Further, the water-soluble conductive polymer may include polypyrrole and polyaniline.

Further, the solvent may be any one selected from aliphatic alcohols, aliphatic ketones, aliphatic carboxylic esters, aliphatic carboxylic amides, aromatic hydrocarbons, aliphatic hydrocarbons, acetonitrile, aliphatic sulfoxides, water, and mixtures thereof.

Further, the transparent electrode may have a surface resistance of 240˜300 Ω/□.

The objects, features and advantages of the present invention will be more clearly understood from the following detailed description.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic sectional view of a transparent electrode without a water-soluble conductive polymer and a compatibilizer;

FIG. 2 is a schematic sectional view of a transparent electrode including a water-soluble conductive polymer and a compatibilizer;

FIG. 3 is a graph showing the surface resistance of a transparent electrode according to the content of polypyrrole; and

FIG. 4 is a graph showing the surface resistance of a transparent electrode according to the content of a compatibilizer.

### DESCRIPTION OF THE PREFERRED EMBODIMENTS

Hereinafter, preferred embodiments of the present invention will be described in detail with reference to the attached drawings.

PEDOT/PSS composition

The PEDOT/PSS composition according to the present invention includes: PEDOT/PSS; a solvent; a compatibilizer, and a water-soluble conductive polymer.

The PEDOT/PSS (poly-3,4-ethylenedioxythiophene/polystyrenesulfonate) includes to thiophene having ethylenedioxy groups in the form of a ring, and has excellent stability in air or to heat. Further, the PEDOT/PSS has an optical bandgap (760˜780 nm or 1.6˜1.7 eV) lower than that of thiophene because of the electron donating effect of ethylenedioxy groups substituted at the third and fourth sites thereof, can be discolored by the difference in electric potential between oxidation and reduction, and can ensure transparency because an absorption band is present in an infrared region in an oxidation state. Moreover, PEDOT/PSS is very suitable for forming a transparent electrode for displays because it is lighter than conventional ITO (indium-tin oxide) and it can be used to obtain a thin film having high flexibility. However, when a transparent electrode is formed using only PEDOT/PSS, there is a problem in that the transparent electrode has a very high surface resistance of 10⁵˜10⁹ Ω/□. Therefore, in the present invention, this problem is solved by adding a compatibilizer and a water-soluble polymer to the PEDOT/PSS. A detailed description thereof is described below.

Meanwhile, when the amount of the PEDOT/PSS in the PEDOT/PSS composition is less than 15 wt %, it is difficult to realize a surface resistance of 1000 Ω/58 or less even though a transparent electrode is formed. Further, when the amount of the PEDOT/PSS in the PEDOT/PSS composition is more than 70 wt %, the coating workability of the PEDOT/PSS composition deteriorates. Therefore, it is preferred that the amount of the PEDOT/PSS in the PEDOT/PSS composition be 15˜70 wt %.

The solvent is used as a dispersant of the PEDOT/PSS composition, and may be one or more kinds of solvents. For example, the solvent may be any one selected from aliphatic alcohols, aliphatic ketones, aliphatic carboxylic esters, aliphatic carboxylic amides, aromatic hydrocarbons, aliphatic hydrocarbons, acetonitrile, aliphatic sulfoxides, water, and mixtures thereof Meanwhile, when the amount of the solvent in the PEDOT/PSS composition is less than 20 wt %, the dispersibility of the PEDOT/PSS composition deteriorates. Further, when the amount of the solvent in the PEDOT/PSS composition is more than 75 wt %, the electrical conductivity of the PEDOT/PSS composition deteriorates. Therefore, it is preferred that the amount of the solvent in the PEDOT/PSS composition be 20˜75 wt %.

The compatibilizer serves to increase the affinity between the PEDOT/PSS and the water-soluble conductive polymer, thus increasing the adhesion at the interface therebetween and uniformly dispersing them. Here, the compatibilizer may be a monomer, oligomer or polymer having one or more anion functional groups or amine functional groups. The anion functional group may include SO₄—, PO₄— and COO—. In addition, polyvalent alcohol including polyvinyl alcohol and hydroxypropyl cellulose (HPC) may be used as the compatibilizer. Such a compatibilizer is advantageous in that it is well combined with PSS exhibiting anions in the PEDOT/PSS.

The water-soluble conductive polymer serves to improve the electrical conductivity of the PEDOT/PSS because it is compatible with the PEDOT/PSS. That is, the water-soluble conductive polymer is rendered compatible with PSS, so that it serves as a medium which can allow charges to easily move between PEDOT and PSS, thereby lowering the insulating characteristics of PSS. Here, the water-soluble conductive polymer is not particularly limited as long as it is a conductive polymer having water-solubility. The water-soluble conductive polymer may be polypyrrole or polyaniline. In this case, since polypyrrole or polyaniline is generally positively-charged in a doped state, the compatibility between the water-soluble conductive polymer and the compatibilizer having a negatively-charged functional group or a partially negatively-charged functional group can be increased by the electrostatic force therebetween.

Further, the PEDOT/PSS composition may further include at least one additive selected from the groups consisting of a second dopant, a dispersion stabilizer, and a binder.

Here, the second dopant, which is a polar solvent for improving the electrical conductivity of the PEDOT/PSS composition, may be at least one selected form the group consisting of dimethylsulfoxide, N-methylpyrrolidone, N,N-dimethylformamide, and N-dimethylacetimide.

Further, the dispersion stabilizer may be ethyleneglycol, sorbitol or the like. The electrical conductivity of the PEDOT/PSS composition is more improved when the polar solvent, as the second dopant, is used in combination with the dispersion stabilizer compared to when only the polar solvent is used independently.

Further, the binder serves to increase the adhesion at the time of coating. Example of the binder may include acrylic binders, epoxy binders, ester binders, urethane binders, ether binders, carboxylic binders, amide binders, and the like.

In addition, the PEDOT/PSS composition may further include a bonding agent, a surfactant, a defoamer, and the like.

PEDOT/PSS film

The PEDOT/PSS film according to the present invention includes: a substrate; and a transparent electrode formed by applying a PEDOT/PSS composition including PEDOT/PSS, a solvent, a compatibilizer and a water-soluble conductive polymer onto the substrate and then drying the PEDOT/PSS composition. That is, in the PEDOT/PSS film, the above-mentioned PEDOT/PSS is applied onto a substrate and then dried to form a transparent electrode. Therefore, a description overlapping with the above description will be omitted or briefly mentioned.

The substrate provides a region where a transparent electrode is formed, and must have transparency in order for it to be used in displays. The substrate may be formed of polyethyleneterephthalate (PET), polycarbonate (PC), polymethylmethacrylate (PMMA), polyethylenenaphthalate (PEN), polyethersulfone (PES), cyclic olefin copolymer (COC), triacetylcellulose (TAC), polyvinyl alcohol (PVA), polyimide (PI), polystyrene (PS), biaxially oriented polystyrene (K resin-containing biaxially oriented polystyrene (BOPS)), glass or reinforced glass or the like, but the present invention is not limited thereto. Meanwhile, in order to improve the adhesion between the substrate and the transparent electrode, the substrate may be high-frequency-treated or primer-treated.

The transparent electrode is formed by applying a PEDOT/PSS composition onto the substrate and then drying the PEDOT/PSS composition. Here, the PEDOT/PSS composition includes PEDOT/PSS, a solvent, a compatibilizer and a water-soluble conductive polymer. In this case, the solvent may be any one selected from aliphatic alcohols, aliphatic ketones, aliphatic carboxylic esters, aliphatic carboxylic amides, aromatic hydrocarbons, aliphatic hydrocarbons, acetonitrile, aliphatic sulfoxides, water, and mixtures thereof Further, the compatibilizer may be a monomer, oligomer or polymer having one or more anion functional groups or amine functional groups. In addition, the PEDOT/PSS composition may further include at least one additive selected from the groups consisting of a second dopant, a dispersion stabilizer, and a binder. The second dopant may be at least a polar solvent selected form the group consisting of dimethylsulfoxide, N-methylpyrrolidone, N,N-dimethylformamide, and N-dimethylacetimide. The dispersion stabilizer may be ethyleneglycol, sorbitol or the like. Example of the binder may include acrylic binders, epoxy binders, ester binders, urethane binders, ether binders, carboxylic binders, amide binders, and the like.

Further, the PEDOT/PSS composition may be applied onto the substrate by screen printing, gravure printing or inkjet printing.

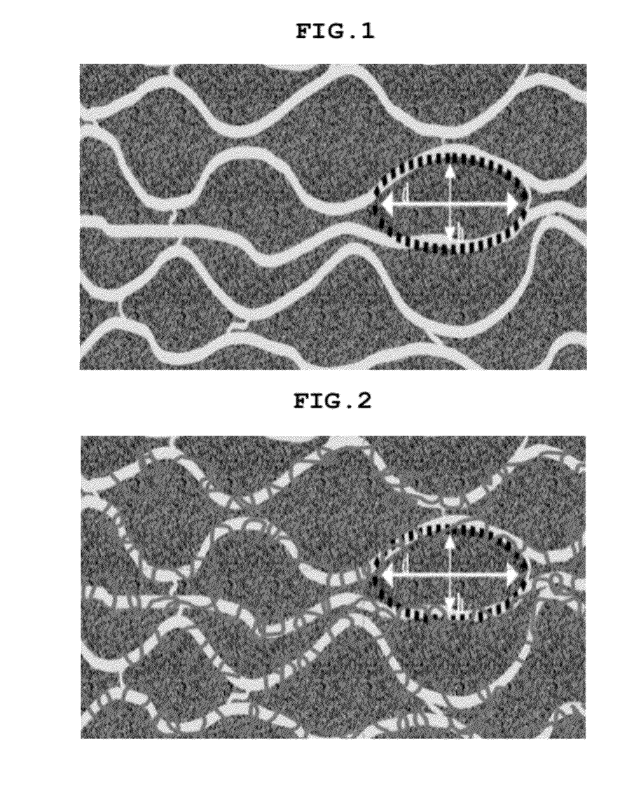

Meanwhile, FIG. 1 is a schematic sectional view of a transparent electrode without a water-soluble conductive polymer and a compatibilizer, and FIG. 2 is a schematic sectional view of a transparent electrode including a water-soluble conductive polymer and a compatibilizer. The principle of a water-soluble conductive polymer decreasing the surface resistance of a transparent electrode will be described with reference to FIGS. 1 and 2.

As shown in FIG. 1, the transparent electrode without a water-soluble conductive polymer and a compatibilizer show that its PEDOT-rich portion (dark portion) is separated by its PSS-rich portion (light portion) up and down (in a direction perpendicular to a substrate) to isolate them from each other, but, on the other hand, show that its PEDOT-rich portion (dark portion) is not completely separated by its PS S-rich portion (light portion) right and left (in a direction horizontal to a substrate) to connect them to each other. Therefore, the transparent electrode without a water-soluble conductive polymer and a compatibilizer is problematic in that its vertical electrical conductivity is lower than its horizontal electrical conductivity.

In contrast, as shown in FIG. 2, the transparent electrode including a water-soluble conductive polymer and a compatibilizer shows that a water-soluble conductive polymer is connected to its PSS-rich portion (light portion). In this case, the water-soluble conductive polymer (entangled in the light portion) makes the charge transfer between its PSS-rich portion (light portion) and its PEDOT-rich portion (dark portion) easy. Therefore, the water-soluble conductive polymer serves to lower the surface resistance of a transparent electrode.

In conclusion, since the transparent electrode according to the present invention includes a water-soluble conductive polymer and a compatibilizer, it can realize a very low surface resistance of 240˜300 Ω/□, which is far lower than the surface resistance (10⁵˜10⁹ Ω/□) of a conventional transparent electrode.

Hereinafter, the present invention will be described in more detail with reference to the following Examples. However, the scope of the present invention is not limited thereto.

### EXAMPLE 1

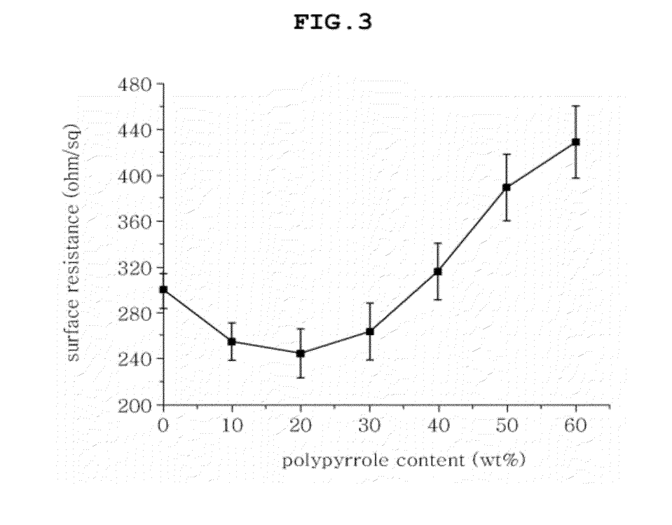

FIG. 3 is a graph showing the surface resistance of a transparent electrode according to the content of polypyrrole.

The transparent electrode according to this Example was formed by applying a PEDOT/PSS composition including PEDOT/PSS, water, a compatibilizer, polypyrrole and dimethylsulfoxide onto a substrate and then drying the PEDOT/PSS composition. The surface resistance of the transparent electrode was measured while maintaining the content of a compatibilizer and the content of dimethylsulfoxide at 5 wt %, respectively, and adjusting the content of polypyrrole.

Referring to FIG. 3, it can be seen that the transparent electrode has an excellent surface resistance of 240˜300 Ω/□ when the content of polypyrrole is 0.1˜36 wt %. Therefore, it is suitable that this transparent electrode is used as a transparent electrode for displays. More preferably, the transparent electrode can exhibit a more excellent surface resistance of 240˜260 Ω/□ when the content of polypyrrole is 10˜30 wt %.

Meanwhile, it can be seen that the surface resistance of the transparent electrode is increased after the content of polypyrrole exceeds 20 wt %. The reason for this is because the content of PEDOT/PSS was relatively decreased.

### EXAMPLE 2

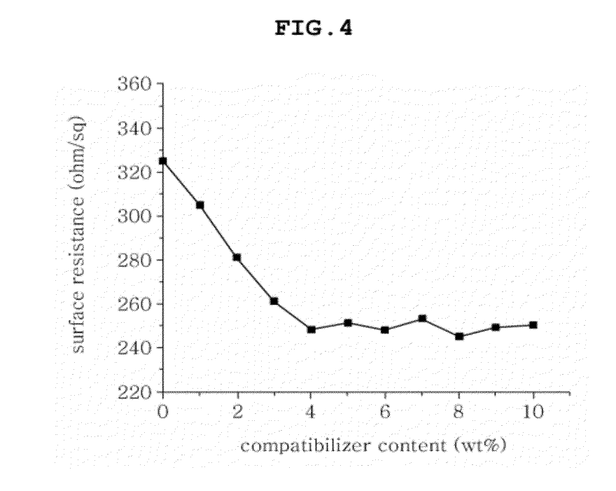

FIG. 4 is a graph showing the surface resistance of a transparent electrode according to the content of a compatibilizer.

The transparent electrode according to this Example was formed by applying a PEDOT/PSS composition including PEDOT/PSS, water, a compatibilizer, polypyrrole and dimethylsulfoxide onto a substrate and then drying the PEDOT/PSS composition. The surface resistance of the transparent electrode was measured while maintaining the content of polypryrrole at 10 wt % and the content of dimethylsulfoxide at 5 wt % and adjusting the content of a compatibilizer.

Referring to FIG. 4, it can be seen that the surface resistance of the transparent electrode is decreased until the content of a compatibilizer is increased to 4 wt %, but that the surface resistance thereof is not greatly changed after the content of a compatibilizer exceeds 4 wt %. Therefore, it is preferred that the content of a compatibilizer be 10 wt % or less in terms of economical efficiency. Meanwhile, in order to use this transparent electrode as a transparent electrode for displays, it is preferred that the surface resistance of the transparent electrode be 300 Ω/□ or less, so it is preferred that the content of a compatibilizer be 1 wt % or more. In conclusion, it is most preferred that the content of a compatibilizer be 1˜10 wt %.

As described above, according to the present invention, since a transparent electrode is formed by adding a compatibilizer and a water-soluble conductive polymer to PEDOT/PSS, the transparent electrode has excellent flexibility, can be easily coated and has a low surface resistance of 240˜300 Ω/□, so that this transparent electrode can be used as a transparent electrode for displays.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Simple modifications, additions and substitutions of the present invention belong to the scope of the present invention, and the specific scope of the present invention will be clearly defined by the appended claims.

What is claimed is:

1. A PEDOT/PSS composition, comprising: PEDOT/PSS; a solvent; a compatibilizer;
and a water-soluble conductive polymer.

2. The PEDOT/PSS composition according to claim 1, wherein the compatibilizer is included in an amount of 1˜10 wt %.

3. The PEDOT/PSS composition according to claim 1, wherein the water-soluble to conductive polymer is included in an amount of 0.1˜36 wt %.

4. The PEDOT/PSS composition according to claim 1, wherein the compatibilizer is a monomer, oligomer or polymer having one or more anion functional groups or amine functional groups.

5. The PEDOT/PSS composition according to claim 4, wherein the anion functional group includes SO₄—, PO₄— and COO—.

6. The PEDOT/PSS composition according to claim 1, wherein the compatibilizer includes polyvalent alcohol.

7. The PEDOT/PSS composition according to claim 6, wherein the polyvalent alcohol includes polyvinyl alcohol and hydroxypropyl cellulose (HPC).

8. The PEDOT/PSS composition according to claim 1, wherein the water-soluble conductive polymer includes polypyrrole and polyaniline.

9. The PEDOT/PSS composition according to claim 1, wherein the solvent is any one selected from aliphatic alcohols, aliphatic ketones, aliphatic carboxylic esters, aliphatic carboxylic amides, aromatic hydrocarbons, aliphatic hydrocarbons, acetonitrile, aliphatic sulfoxides, water, and mixtures thereof.

10. A PEDOT/PSS film, comprising:
a substrate; and
a transparent electrode formed by applying a PEDOT/PSS composition including PEDOT/PSS, a solvent, a compatibilizer and a water-soluble conductive polymer onto the substrate and then drying the PEDOT/PSS composition.

11. The PEDOT/PSS film according to claim 10, wherein the compatibilizer includes a monomer, oligomer or polymer having one or more anion functional groups or amine functional groups.

12. The PEDOT/PSS film according to claim 11, wherein the anion functional group includes SO₄—, PO₄— and COO—.

13. The PEDOT/PSS film according to claim 10, wherein the compatibilizer includes polyvalent alcohol.

14. The PEDOT/PSS film according to claim 13, wherein the polyvalent alcohol includes polyvinyl alcohol and hydroxypropyl cellulose (HPC).

15. The PEDOT/PSS film according to claim 10, wherein the water-soluble conductive polymer includes polypyrrole and polyaniline.

16. The PEDOT/PSS film according to claim 10, wherein the solvent is any one selected from aliphatic alcohols, aliphatic ketones, aliphatic carboxylic esters, aliphatic carboxylic amides, aromatic hydrocarbons, aliphatic hydrocarbons, acetonitrile, aliphatic sulfoxides, water, and mixtures thereof.

17. The PEDOT/PSS film according to claim 10, wherein the transparent electrode has a surface resistance of 240˜300 Ω/□.
